(19) United States
(12) Patent Application Publication
(10) Pub. No.: US 2018/0314112 A1
(43) Pub. Date: Nov. 1, 2018

(54) DISPLAY DEVICE AND METHOD OF INCREASING THE TRANSMITTANCE OF A DISPLAY DEVICE

(71) Applicant: SABIC Global Technologies B.V., Bergen op Zoom (NL)

(72) Inventors: Zhe Chen, Shanghai (CN); Jong Woo Lee, Seoul (KR); Byungsoo Ko, Sungnam City (KR)

(21) Appl. No.: 15/763,540

(22) PCT Filed: Sep. 29, 2016
(86) PCT No.: PCT/IB2016/055838

§ 371 Date: Mar. 27, 2018

Related U.S. Application Data
(60) Provisional application No. 62/234,436, filed on Sep. 29, 2015.

(51) Int. Cl. G02F 1/1335; G02F 1/1368

(52) U.S. Cl. CPC G02F 1/133617; G02F 1/133621; G02F 2202/36; G02F 1/1368; G02F 2001/133614; G02F 1/133528

(57) ABSTRACT

A liquid crystal display device (10), comprising: a blue emitting backlight unit (12); a shutter substrate (14) with thin film transistors (34); a first polarizer (28) on the surface (16) facing the blue backlight unit (12); a liquid crystal layer (20) disposed adjacent to an opposite surface (18) of the shutter substrate (14); a second polarizer (30); and a color change layer (22) comprising a polymer and a quantum dot material, wherein the color change layer (22) is disposed on a surface of a color change substrate (24).

### BACKGROUND

Existing display products generally utilize white light emitting diode (LED) backlight sources in combination with ordinary color filters to provide a color display product, which typically result in a low light source utilization rate and a narrow color gamut of display. For example, each color pigment absorbs other color regions, for example, the red pigment absorbs the wavelength of green and blue colors, wherein the light with a wavelength coincident with the red pigment transmits the red sub-pixel area. As a result, the transmittance of each color is only about 33%.

Quantum dots are unique semiconductor nanocrystals that possess several useful properties such as photoluminescence. Photoluminescence refers to absorption of light by a quantum dot at one wavelength and emission of light at a second wavelength. Typically, the absorbed wavelength is shorter than the emitted wavelength.

Quantum dots have been used in light emitting diodes, where a composite of various color emitting quantum dots are illuminated by a light source. Typically, a composite of red, green, and blue emitting quantum dots are combined with a white light backlight source as part of a liquid crystal display (LCD). However, such approach requires color filters to cancel the unwanted portion of the white light in order to produce a desired color. Such a process of generating white light and refiltering the light to produce a desired color is inefficient. Therefore, there is a need for a higher efficiency of transmittance while maintaining or reducing power consumption.

### BRIEF DESCRIPTION

A liquid crystal display device comprises: a blue backlight unit; a shutter substrate having a surface disposed adjacent to the blue backlight unit; a liquid crystal layer disposed adjacent to an opposite surface of the shutter substrate; and a color change layer comprising a polymer and a quantum dot material, wherein the color change layer is disposed on a surface of a color change substrate.

A method of increasing transmittance of a device comprises: passing light through a backlight unit, activating a blue light source in the backlight unit, passing blue light from the blue light source through a first polarizing layer and a shutter substrate, passing the blue light through a liquid crystal layer and a second polarizing layer, coating a color change substrate with a color change layer comprising a polymer and a quantum dot material, and passing the blue light through the color change layer and the color change substrate, wherein the color change layer changes the wavelength of light passing through the color change layer.

The above described and other features are exemplified by the following FIGURES and detailed description.

### BRIEF DESCRIPTION OF THE DRAWINGS

Refer now to the FIGURE, which is an exemplary embodiment, and wherein the like elements are numbered alike.

FIG. 1 is an illustration of a cross-sectional view of a device including a color change layer comprising quantum dots.

### DETAILED DESCRIPTION

A liquid crystal display device that uses a single wavelength of light in conjunction with a color change layer can provide improved operating characteristics and improved efficiency.

The liquid crystal display device disclosed herein can include a backlight unit, wherein the backlight unit can include a blue light source configured to emit blue light. The blue backlight unit is configured to emit blue monochromatic light, having a wavelength of 440 nm to 450 nm. The blue backlight unit can include a blue light emitting diode.

The device can include a liquid crystal layer positioned between a shutter substrate and a color change substrate. The liquid crystal layer can include rod-shaped molecules that naturally form into thin layers with a natural alignment. By controlling the voltage applied across the liquid crystal layer, light can be allowed to pass through in varying amounts.

The device can include a color change layer including a polymer, e.g., a thermoplastic polymer or a thermoset polymer, and a quantum dot material, wherein the color change layer can be disposed on a surface of a color change substrate. The color change layer can be a thin film, for example, a thin film having a thickness of less than or equal to 10 micrometers (μm), for example, less than or equal to 5 μm, for example, less than or equal to 3 μm, for example, less than or equal to 2 μm, for example, less than or equal to 1.5 μm. For example, the thin film can have a thickness of 0.5 μm to 10 μm, for example, 1.5 μm to 8 μm, for example, 2 μm to 7 μm, for example, 3 μm to 5 μm, or for example, 0.5 μm to 3 μm. The color change layer can include two or more different light emitting quantum dots, each light emitting quantum dot configured to emit into distinct light wavelength regions.

The color change layer can include polymers as well as combinations of polymers with elastomers and/or thermoset polymers. Exemplary materials can include elastomeric materials or thermoset materials. The color change layer can include thermoplastic polymers. Thermoplastic polymers of the color change layer can include, but are not limited to, oligomers, polymers, ionomers, dendrimers, copolymers such as graft copolymers, block copolymers (e.g., star block copolymers, random copolymers, and the like) or a combination comprising at least one of the foregoing. Examples of such thermoplastic polymers include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyethylene terephthalate (PET), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluorides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination comprising at least one of the foregoing.

The quantum dot material can include quantum dots. Quantum dots are nano-particulate semiconductors, whose excitons are confined in all three spatial dimensions, and possess properties that lie between those of bulk semiconductors and those of discrete molecules. The properties of quantum dots can be engineered. For example, quantum dots that comprise the same elements can be made to emit light at different wavelengths by changing the size of the relative quantum dot.

The quantum dot can include compounds of Group II-VI of the Periodic Table, compounds of Group III-V of the Periodic Table, compounds of Group IV-VI of the Periodic Table, or a Group IV compound of the Periodic Table, as well a combination comprising at least one of the foregoing. For example, a compound of Group II-VI can include CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, CdZnS, CdZnSe, CdZnTe, CdHgS, CdHgSe, CdUgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe. A compound from Group III-V an include GaN, G-aP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb InAlNP, InAlNAs, InAlNSb, InAlPAs, and InAlPSb. A compound from Group IV-VI can include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe. A compound from Group IV can include Si, Ge, SiC, and SiGe.

Exemplary quantum dots can include zinc sulfide (ZnS), zinc oxide (ZnO), gallium nitride (GaN), zinc selenide (ZnSe), gallium selenide (GaSe), zinc telluride (ZnTe), cadmium telluride (CdTe), gallium arsenide (GaAs), lead telluride (PbTe), cadmium selenide (CdSe), cadmium sulfide (CdS), indium arsenide (InAs), and indium phosphide (InP), and cadmium tellurium sulfide (CdTeS). The quantum dots can include a core/shell structure where the core can include at least one of CdSe, CdTe, CdS, ZnSe, ZnTe, ZnS, HgTe, and HgS, and the shell can include at least one of CdSe, CdTe, CdS, ZnSe, ZnTe, ZnS, HgTe, and HgS, wherein the core material can be different than the shell material. For example, the core/shell structure can include CdSe/ZnS, InP ZnS, PbSe/PbS, CdSe/CdS, CdTe/CdS or CdTe/ZnS.

A quantum dot can have an average size of 15 nanometers (nm) or less, 10 nm or less, 8 m or less, or 6 nm or less. The color change layer can include a first layer including a first quantum dot material, and a second layer including a second quantum dot material, wherein the average particle size of the first quantum dot material can be different than the average particle size of the second quantum dot material.

The quantum dot material can include red light emitting quantum dots and green emitting quantum dots. The quantum dot material can consist essentially of or consist of red light emitting quantum dots and green emitting quantum dots. The wavelength of the green quantum dot after excitation can be 520 nm to 550 nm. The wavelength of the red quantum dot after excitation can be 620 nm to 650 nm.

The color change layer can include a pixel, wherein the pixel comprises a plurality of sub-pixels, wherein each sub-pixel includes a quantum dot. The pixel can include a red sub-pixel including red light emitting quantum dot and a green sub-pixel including a green light emitting quantum dot. The pixel can include a red sub-pixel including red light emitting quantum dot, a green sub-pixel including a green light emitting quantum dot, and a blue sub-pixel, wherein the blue sub-pixel is transparent. The blue sub-pixel may not include quantum dots. For example, the subregion corresponding to the blue sub-pixel may be transparent to allow the blue light from the blue backlight unit to pass through substantially without blocking.

The device may include at least one polarizer layer. The shutter substrate may include a first polarizer layer disposed on the surface of the shutter substrate adjacent to the blue back-light. A second polarizer layer can be positioned between the color change layer and the liquid crystal layer. The polarizer layer can be a reflective polarizer layer that transmits light with a single polarization state and reflects the remaining light. The reflective polarizer layer can include birefringent reflective polarizers, fiber polarizers, and collimating multilayer reflectors. However, any suitable type of reflective polarizer may be used for the reflective polarizer, e.g., multilayer optical film (MOF) reflective polarizers; diffusely reflective polarizing film (DRPF), such as continuous/disperse phase polarizers; wire grid reflective polarizers; or cholesteric reflective polarizers.

The shutter substrate may include a thin-film-transistor. The thin-film-transistor can be attached to the surface of the shutter substrate opposite the first polarizer layer. Each sub-pixel can have a corresponding transistor or switch for controlling voltage applied to the liquid crystal layer.

The device can have a liquid crystal display panel transmittance of greater than 5%, greater than 10%, greater than 15%, and greater than 20%. The device can have a liquid crystal display panel transmittance of 5% to 25%, of 10% to 20%, and of 15% to 20%.

The device including the color change layer comprising quantum dots is generally much brighter than the conventional LCD display as a result of its wider color gamut. For conventional LCDs to achieve the same color gamut as the present device, the power efficiency would be much lower than the present device.

The disclosure also provides a method of increasing transmittance of a device that can include passing light through a backlight unit, activating a blue light source in the backlight unit, passing blue light from the blue light source through a first polarizing layer and a shutter substrate, passing the blue light through a liquid crystal layer and a second polarizing layer, coating a color change substrate with a color change layer comprising a polymer (e.g., a thermoplastic polymer or a thermoset polymer) and a quantum dot material, and passing the blue light through the color change layer and the color change substrate. The color change layer can change the wavelength of light passing through the color change layer.

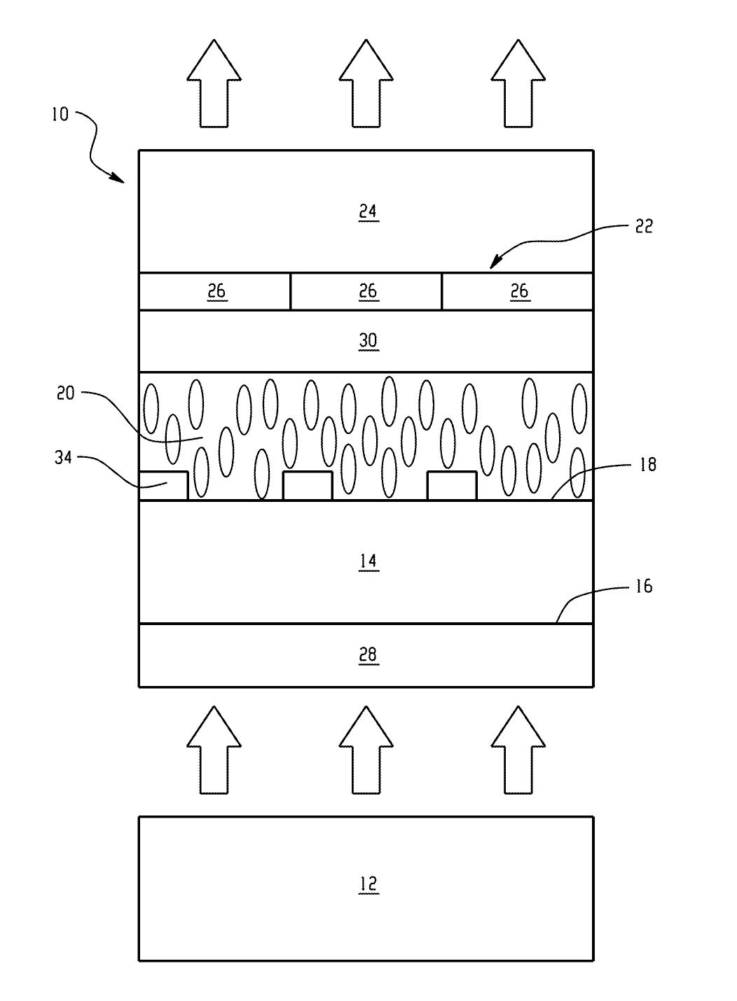

As shown in FIG. 1, a liquid crystal display device 10 can include a backlight unit 12 and a shutter substrate 14. The shutter substrate can have a surface 16 disposed adjacent to the blue backlight unit. The liquid crystal display device 10 can include a liquid crystal layer 20 that can be disposed adjacent to an opposite surface 18 of the shutter substrate 14.

The device 10 can include a color change layer 22 that can include the quantum dot material. The color change layer 22 can be disposed on a surface of a color change substrate 24. The color change layer 22 can include a pixel, wherein the pixel can include a plurality of sub-pixels 26, wherein each sub-pixel 26 can include a quantum dot.

The shutter substrate 14 may include a first polarizer layer 28 disposed on the surface of the shutter substrate 14 adjacent to the blue back-light. A second polarizer layer 30 can be positioned between the color change layer 22 and the liquid crystal layer 20. The shutter substrate 14 can include a thin-film-transistor 34.

The following example are merely illustrative of the device disclosed herein and are not intended to limit the scope hereof. Unless otherwise stated, all examples were based upon simulations.

### EXAMPLES

Table 1 demonstrates a panel transmittance calculation for each component of the LCD panel, wherein the LCD panel includes a conventional color filter. Luminance was measured in nit which is equivalent to 1 candela per square meter (cd/m²). A candela per square meter (cd/m²) is a SI derived unit of luminance. The unit is based on the candela, the SI unit of luminous intensity, and the square meter, the SI unit of area. Accordingly, 748 nits are equivalent to 748 cd/m² and 10,000 nits are equivalent to 10,000 cd/m².

TABLE 1
Panel Transmittance of a Conventional LCD Panel including
a Color Filter

| | | |
|---|---|---|
| Luminance of Panel (nit) | 748 | |
| | Panel Transmittance | 7% |
| | Color Filter | 35% |
| | Liquid Crystal | 95% |
| | TFT | 50% |
| | Absorbing Polarizer | 45% |
| Luminance of BLU (nit) | 10000 | |

TFT = thin-film-transistor
BLU = back light unit

Table 2 demonstrates a panel transmittance calculation for the disclosed device, which has a 60% quantum dot color change layer efficiency.

TABLE 2
Panel Transmittance of a LCD Panel including a Color
Change Layer

| | | |
|---|---|---|
| Luminance of Panel (nit) | 1283 | |
| | Panel Transmittance | 13% |
| | QD Color Change Layer | 60% |
| | Liquid Crystal | 95% |
| | TFT | 50% |
| | Absorbing Polarizer | 45% |
| Luminance of BLU (nit) | 10,000 | |

The transmittance of the color change layer is 60%, as compared to a conventional color filter that has a transmittance of only 35%. The results in Table 2 indicate that the device including the color change layer comprising quantum dots is generally much brighter than a conventional LCD display.

Table 3 includes a simulation of panel transmittance of the quantum dot color change layer efficiency.

TABLE 3
Panel Transmittance and Color Change Layer Efficiency

| Efficiency of QD Color Change Layer | Panel Transmittance |
|---|---|
| 50% | 11% |
| 60% | 13% |
| 70% | 15% |
| 80% | 17% |
| 90% | 19% |

As can be seen from Table 3, the efficiency of the quantum dot color layer can be increased as compared to a conventional quantum dot display. For example, the efficiency can be greater than or equal to 50%, for example, greater than or equal to 60%, for example, greater than or equal to 70%, for example, greater than or equal to 80%, for example, greater than or equal to 90%. Table 3 also demonstrates that the panel transmittance increases as the efficiency of the color change layer increases.

The device and methods of making disclosed herein include at least the following embodiments:

### Embodiment 1

A liquid crystal display device comprising: a blue backlight unit; a shutter substrate having a surface disposed adjacent to the blue backlight unit; a liquid crystal layer disposed adjacent to an opposite surface of the shutter substrate; and a color change layer comprising a polymer and a quantum dot material, wherein the color change layer is disposed on a surface of a color change substrate.

### Embodiment 2

The device of Embodiment 1, wherein the quantum dot material includes quantum dots, wherein an average diameter of the quantum dots is 15 nm or less.

### Embodiment 3

The device of any of Embodiments 1-2, wherein the quantum dot material includes quantum dots, wherein an average diameter of the quantum dots is 10 nm or less.

### Embodiment 4

The device of any of Embodiments 1-3, wherein the quantum dot material includes red light emitting quantum dots and green light emitting quantum dots.

### Embodiment 5

The device of any of Embodiments 1-4, wherein the color change layer includes two or more different light emitting quantum dots, each light emitting quantum dot configured to emit into distinct light wavelength regions.

### Embodiment 6

The device of any of Embodiments 1-5, wherein the color change layer includes a pixel, wherein the pixel comprises a plurality of sub-pixels, wherein each sub-pixel includes a quantum dot.

### Embodiment 7

The device of any of Embodiments 1-6, wherein the color change layer includes a pixel, wherein the pixel comprises a red sub-pixel including a red light emitting quantum dot and a green sub-pixel including a green light emitting quantum dot.

### Embodiment 8

The device of any of Embodiments 1-7, wherein the color change layer includes a pixel, wherein the pixel comprises a red sub-pixel including a red light emitting quantum dot, a green sub-pixel including a green light emitting quantum dot, and a blue sub-pixel, wherein the blue sub-pixel is transparent.

### Embodiment 9

The device of Embodiment 8, wherein the blue sub-pixel does not include quantum dots.

### Embodiment 10

The device of any of Embodiments 1-9, wherein the color change layer includes a first layer including a first quantum dot material, and a second layer including a second quantum dot material, wherein the average particle size of the first quantum dot material is different than the average particle size of the second quantum dot material.

### Embodiment 11

The device of any of Embodiments 1-10, wherein a first polarizer layer is disposed between the blue backlight unit and the shutter substrate.

### Embodiment 12

The device of any of Embodiments 1-11, wherein the shutter substrate includes a thin-film-transistor.

### Embodiment 13

The device of Embodiment 12, wherein the thin-film-transistor is attached to a surface of the shutter substrate opposite the first polarizer layer.

### Embodiment 14

The device of any of Embodiments 1-12, further comprising a second polarizer layer between the color change layer and the liquid crystal layer.

### Embodiment 15

The device of any of Embodiments 1-14, wherein the color change layer is a thin film.

### Embodiment 16

The device of Embodiment 15, wherein the thin film has a thickness of less than or equal to 3 micrometers.

### Embodiment 17

The device of any of Embodiments 1-16, wherein the liquid crystal display panel transmittance of the device is greater than 10%.

### Embodiment 18

The device of Embodiment 17, wherein the transmittance is 10% to 20%.

### Embodiment 19

A method of increasing transmittance of a device including passing light through a backlight unit, activating a blue light source in the backlight unit, passing blue light from the blue light source through a first polarizing layer and a shutter substrate, passing the blue light through a liquid crystal layer and a second polarizing layer, coating a color change substrate with a color change layer comprising a polymer and a quantum dot material, and passing the blue light through the color change layer and the color change substrate, wherein the color change layer changes the wavelength of light passing through the color change layer.

### Embodiment 20

The method of Embodiment 19, wherein the liquid crystal panel transmittance of the device is greater than 10%.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A liquid crystal display device, comprising:
a blue backlight unit;
a shutter substrate having a surface disposed adjacent to the blue backlight unit;
a liquid crystal layer disposed adjacent to an opposite surface of the shutter substrate; and
a color change layer comprising a polymer and a quantum dot material, wherein the color change layer is disposed on a surface of a color change substrate.

2. The device of claim 1, wherein the quantum dot material includes quantum dots, wherein an average diameter of the quantum dots is 15 nm or less.

3. The device of claim 1, wherein the quantum dot material includes quantum dots, wherein an average diameter of the quantum dots is 10 nm or less.

4. The device of claim 1, wherein the quantum dot material includes red light emitting quantum dots and green light emitting quantum dots.

5. The device of claim 1, wherein the color change layer includes two or more different light emitting quantum dots, each light emitting quantum dot configured to emit into distinct light wavelength regions.

6. The device of claim 1, wherein the color change layer includes a pixel, wherein the pixel comprises a plurality of sub-pixels, wherein each sub-pixel includes a quantum dot.

7. The device of claim 1, wherein the color change layer includes a pixel, wherein the pixel comprises a red sub-pixel including a red light emitting quantum dot and a green sub-pixel including a green light emitting quantum dot.

8. The device of claim 1, wherein the color change layer includes a pixel, wherein the pixel comprises a red sub-pixel including a red light emitting quantum dot, a green sub-pixel including a green light emitting quantum dot, and a blue sub-pixel, wherein the blue sub-pixel is transparent.

9. The device of claim 8, wherein the blue sub-pixel does not include quantum dots.

10. The device of claim 1, wherein the color change layer includes a first layer including a first quantum dot material, and a second layer including a second quantum dot material, wherein the average particle size of the first quantum dot material is different than the average particle size of the second quantum dot material.

11. The device of claim 1, wherein a first polarizer layer is disposed between the blue backlight unit and the shutter substrate.

12. The device of claim 1, wherein the shutter substrate includes a thin-film-transistor.

13. The device of claim 12, wherein the thin-film-transistor is attached to a surface of the shutter substrate opposite the first polarizer layer.

14. The device of claim 1, further comprising a second polarizer layer between the color change layer and the liquid crystal layer.

15. The device of claim 1, wherein the color change layer is a thin film.

16. The device of claim 15, wherein the thin film has a thickness of less than or equal to 3 micrometers.

17. The device of claim 1, wherein the liquid crystal display panel transmittance of the device is greater than 10%.

18. The device of claim 17, wherein the transmittance is 10% to 20%.

19. A method of increasing transmittance of a device, comprising:
passing light through a backlight unit;
activating a blue light source in the backlight unit;
passing blue light from the blue light source through a first polarizing layer and a shutter substrate;
passing the blue light through a liquid crystal layer and a second polarizing layer;
coating a color change substrate with a color change layer comprising a polymer and a quantum dot material; and
passing the blue light through the color change layer and the color change substrate;
wherein the color change layer changes the wavelength of light passing through the color change layer.

20. The method of claim 19, wherein the liquid crystal panel transmittance of the device is greater than 10%.
